(19) United States
(12) Patent Application Publication
(10) Pub. No.: US 2025/0191283 A1
(43) Pub. Date: Jun. 12, 2025

(54) Virtual Relighting for Video Conferencing

(71) Applicant: Apple Inc., Cupertino, CA (US)

(72) Inventors: Michael W. Tao, San Jose, CA (US); Hjalte Wedel Vildhoej, Cupertino, CA (US); Johnnie B. Manzari, San Francisco, CA (US); Max-Olivier C. Van Bastelaer, Cambridge (GB); Morten Nobel-Jorgensen, San Jose, CA (US); Rasmus R. Jensen, Cupertino, CA (US); Seyyedhossein Mousavi, Emerald Hills, CA (US); Toke Jansen, Holte (DK)

(21) Appl. No.: 18/962,333

(22) Filed: Nov. 27, 2024

Related U.S. Application Data
(60) Provisional application No. 63/607,442, filed on Dec. 7, 2023.

(51) Int. Cl. G06T 15/50; G06T 7/50

(52) U.S. Cl. CPC G06T 15/506; G06T 7/50; G06T 2207/10016; G06T 2207/20081; G06T 2207/30196

(57) ABSTRACT

Devices, methods, and non-transitory computer-readable media are disclosed herein for augmenting live video image streams with “virtual lighting” visual effects. For example, a first electronic device may obtain a video image stream. Then, for each of one or more images in the video stream, the electronic device may: assign depth values to at least a foreground portion of each image; estimate surface normals for at least the foreground portion of each image based, at least in part, on the assigned depth values (and, e.g., using a machine learning (ML)-based model); and augment each image with at least a specified virtual lighting visual effect based, at least in part, on the estimated surface normals. Finally, the first electronic device may transmit the first augmented output image to a second electronic device. The virtual lighting effect may comprise a specification of one or more properties of one or more virtual light sources.

### TECHNICAL FIELD

This disclosure relates generally to the field of audio and video data streaming. More particularly, but not by way of limitation, it relates to techniques for augmenting live video image streams with various visual effects, e.g., virtual lighting visual effects, that are composited directly into the video image stream.

### BACKGROUND

The advent of portable integrated computing devices has caused a wide proliferation of cameras and other video capture-capable devices. These integrated computing devices commonly take the form of smartphones, tablets, or laptop computers, and typically include general purpose computers, cameras, sophisticated user interfaces including touch-sensitive screens, and wireless communications abilities through Wi-Fi, Bluetooth, LTE, HSDPA, New Radio (NR), and other cellular-based or wireless technologies. The wide proliferation of these integrated devices provides opportunities to use the devices' capabilities to perform tasks that would otherwise require dedicated hardware and software.

For example, portable integrated computing devices, such as smartphones, tablets, and laptops may have two or more embedded cameras. These cameras generally amount to lens/camera hardware modules that may be controlled through the use of a general-purpose computer using firmware and/or software (e.g., applications, or “apps”) and a user interface, including touch-screen buttons, fixed buttons, and/or touchless controls, such as voice control. The integration of high-quality cameras into these portable integrated communication devices, such as smartphones, tablets, and laptop computers, has enabled users to capture and share images and videos in ways never before possible. It is now common for users' smartphones to be their primary image capture device of choice.

Along with the rise in popularity of photo and video sharing via portable integrated computing devices having integrated cameras has come a rise in videoconferencing (and other audiovisual (AV) content sharing sessions) via such portable integrated computing devices. In particular, users often engage in videoconferencing calls or meetings where they share video images and/or other graphical content, with the video images typically being captured by a front-facing camera on the device, i.e., a camera that faces in the same direction as the camera device's display screen.

However, there remains an additional need for the ability to augment live video image streams in various ways, such as: augmentation with depth-aware visual effects, e.g., to draw attention to a subject of the live video image stream, remove focus from the background of the live video image stream, and/or allow for more personal/stylistic changes to be applied to the live video image streams, including the use of so-called virtual lighting or “re-lighting” effects, which may be composited directly into the video image stream. Such effects are desirably: (1) lightweight in terms of computational resources and power required, such that they may be applied to a video image stream as it is being captured in real-time (and possibly for minutes or hours of capture at a time); and (2) physically realistic, in terms of their application to real (or virtual) three-dimensional (3D) objects in the scene that is being captured in the video image stream.

### SUMMARY

Devices, methods, and non-transitory computer-readable media (CRM) are disclosed herein to enable the augmentation of live video image streams with various visual effects and/or other enhancements, e.g., virtual lighting visual effects that may be composited directly into the video image stream, such that the augmented video image stream could be displayed at the device of the user that captured the live video image stream and/or transmitted to the device of another user for display.

For example, a first image processing method is disclosed herein, comprising: obtaining, at a first electronic device, a video image stream comprising a plurality of images of a scene captured by a first image capture device; and, then, for at least a first image of the video image stream: assigning depth values to at least a foreground portion of the first image; estimating surface normals for at least the foreground portion of the first image based, at least in part, on the assigned depth values; augmenting the first image with at least a first visual effect based, at least in part, on the estimated surface normals, wherein the first visual effect comprises a specified virtual lighting effect; and transmitting the first augmented output image to a second electronic device, e.g., as part of a videoconferencing application.

According to other embodiments, estimating the surface normals comprises using a machine learning (ML) or artificial intelligence (AI)-based model.

According to other embodiments, the steps of: assigning, estimating, augmenting, and transmitting are further performed for each image of the video stream.

According to other embodiments, the foreground portion of the first image comprises at least one human subject.

According to other embodiments, the specified virtual lighting effect comprises a specification of at least one of: (a) a color of a virtual light source being added to the scene; (b) an intensity level of a virtual light source being added to the scene; (c) an angle of a virtual light source being added to the scene with respect to the first image capture device; (d) a number of virtual light sources being added to the scene; or (e) a position of one or more virtual light sources being added to the scene.

According to other embodiments, the specified virtual lighting effect comprises a virtual light source that is modeled as being added to the scene at an infinity distance.

According to other embodiments, the first visual effect comprises an application of one or more temporal stability constraints.

According to other embodiments, the first visual effect comprises automatically determining an angle of a virtual light source being added to the scene with respect to the first image capture device.

According to other embodiments, the specified virtual lighting effect comprises modeling an effect of a virtual light source being added to the scene on a virtual background for the scene.

Various non-transitory computer-readable media (CRM) embodiments are also disclosed herein. Such CRM are readable by one or more processors. Instructions may be stored on the CRM for causing the one or more processors to perform any of the embodiments disclosed herein. Various electronic devices are also disclosed herein, e.g., comprising memory, one or more processors, image capture devices, displays and/or other electronic components, and programmed to perform in accordance with the various method and CRM embodiments disclosed herein.

### BRIEF DESCRIPTION OF THE DRAWINGS

FIG. 1 illustrates an exemplary workflow for the application of virtual lighting visual effects to a video image stream, according to one or more embodiments.

FIGS. 2A and 2B illustrate various examples of virtual lighting visual effects for augmenting video image streams, according to one or more embodiments.

FIG. 3 is a flow chart illustrating a method of augmenting a live video image stream with virtual lighting visual effects, according to various embodiments, according to various embodiments.

FIG. 4 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

The techniques disclosed herein relate generally to augmenting a live video image stream (e.g., as part of a videoconferencing session) with certain visual effects (e.g., performing certain image processing effects related to virtual lighting positions and/or angles), as well as providing an interface for a user to specify various characteristics of the visual effects being applied to the video image stream in real-time.

In some cases, the video image augmentation can involve segmenting particular objects (or classes of objects, such as foreground and background objects, human subjects, faces, etc.) from the video images into multiple layers, assembling the multiple layers of the original video image according to a desired composition technique or visual effect (e.g., by applying the desired augmentation to one or more of the layers), and then compositing the various layers into an augmented video image before transmission, such that a standard video image stream may be transmitted to another device, e.g., via a network.

### Exemplary Workflow for the Application of Virtual Lighting Effects to Images Captured by Electronic Devices

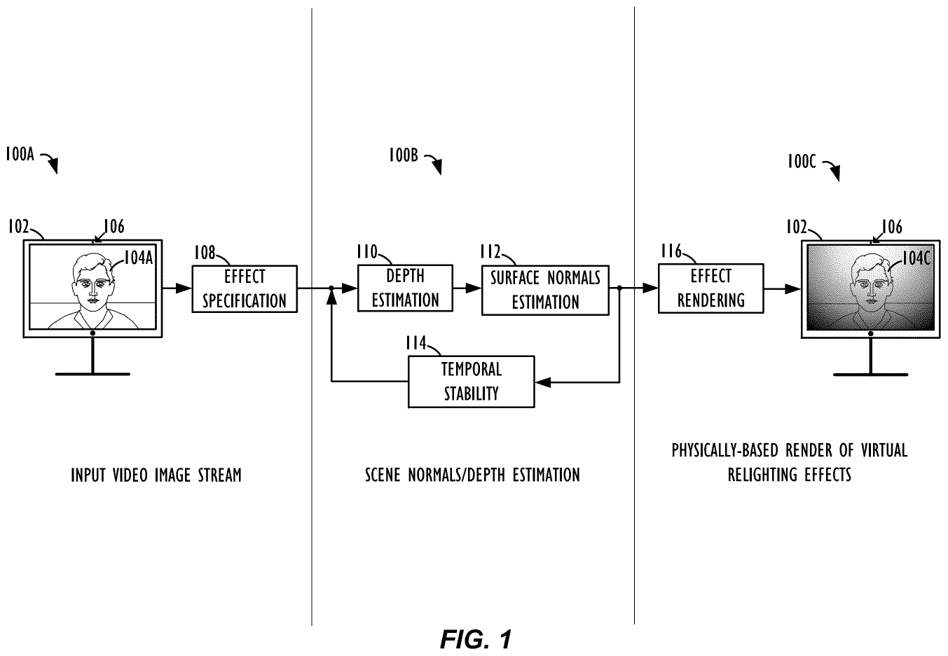

Turning now to FIG. 1, an exemplary workflow 100 for the application of virtual lighting visual effects to a video image stream are shown, according to one or more embodiments.

Turning first to workflow section 100A, a first device 102 comprises an embedded image capture device 106 (e.g., a “webcam,” or the like), which may be connected internally to the other components of first device 102 and may be used to capture an input video image stream comprising one or more images (104A) of the scene surrounding first device 102, e.g., including one or more human subjects. One or more characteristics of a visual effect, e.g., a virtual lighting visual effect, that is to be applied to the captured images may be specified at block 108, e.g., via a suitable user interface or programmatic interface.

Turning next to workflow section 100B, a process of scene normals and/or depth estimation may be performed on the images of the captured input video image stream. For example, at block 110, a scene depth estimation operation may be performed on at least a foreground portion of the images from the input video image stream. In some embodiments, the scene depth estimation operation may comprise the use of one or more depth sensors. In other embodiments, the scene depth estimation operation may comprise the use of one or more machine learning (ML) or artificial intelligence (AI)-based models configured to estimated depth from color image data, or the like.

At block 112, a surface normals estimation operation may be performed on at least the foreground portions of the images from the input video image stream. In some embodiments, estimating the surface normals comprises using a ML or AI-based model on the input image data. In some such embodiments, the surface normals may be estimated directly from the input image data, while, in other embodiments, the surface normals may be estimated based, at least in part, on the scene depth estimates produced at block 110 (e.g., by computing a gradient of the depth map). For example, in some ML or AI-based implementations, a neural network may be utilized that comprises a pre-trained depth estimation pathway and a distinct surface normals estimation pathway, i.e., with its own encoder-bottleneck-decoder architecture. According to some such implementations, at certain layers, the surface normals estimation pathway may tap out certain features from the depth estimation pathway and concatenate them to its own features before producing the final estimated surface normals. Utilizing a separate pathway for the surface normals estimation may allow the network to achieve high quality within a small computational budget (e.g., by allowing the surface normals estimation pathway to reuse certain features from the depth estimation pathway where it is useful—but also to extract new features where more information is needed).

In some such embodiments, surface normals may be estimated for the entire scene as captured in the input images, i.e., as opposed to only operating on the foreground portions of the captured input images. In some such embodiments, an ML or AI-based model used in the estimation of surface normals may have the notion of temporal consistency constraints built into it during training, e.g., wherein the “previous” state(s) (and/or “future” state(s), if such information is available, e.g., in a buffer) of the network is fed into the “next” state of the network during the training operation, and wherein large or abrupt changes in the estimated surface normals from one captured image frame to the next captured image frame are penalized.

According to some embodiments, at block 114, additional temporal stability constraints may be applied to the output of the surface normal estimation module at block 112. For example, an optical flow (OF) vector field may be computed by warping the depth/normals estimation from a previous captured input video image to the current captured input video image. Then, an exponential moving average (or other desired filtering operation) may be applied between the depth/normals estimated for the previous captured input video image and the depth/normals estimated for the current captured input video image in order to produce a temporally-smoothed depth/surface normals estimate for the current captured input video image, which may then be used in the physically-based rendering of the virtual lighting effects at workflow section 100C.

Finally, turning to workflow section 100C, the aforementioned physically-based rendering of the virtual lighting effects may be applied to the current captured input video image at block 116, e.g., based, at least in part, on the (optionally temporally smoothed) surface normals estimated from workflow section 100B, as will be described in further detail below. If desired, the augmented version of the one or more captured images having the applied virtual lighting effects (104C) may be displayed on a display of first device 102 and/or transmitted to another electronic device, e.g., via a videoconferencing application.

### Exemplary Virtual Lighting Visual Effects for Augmenting Video Image Streams

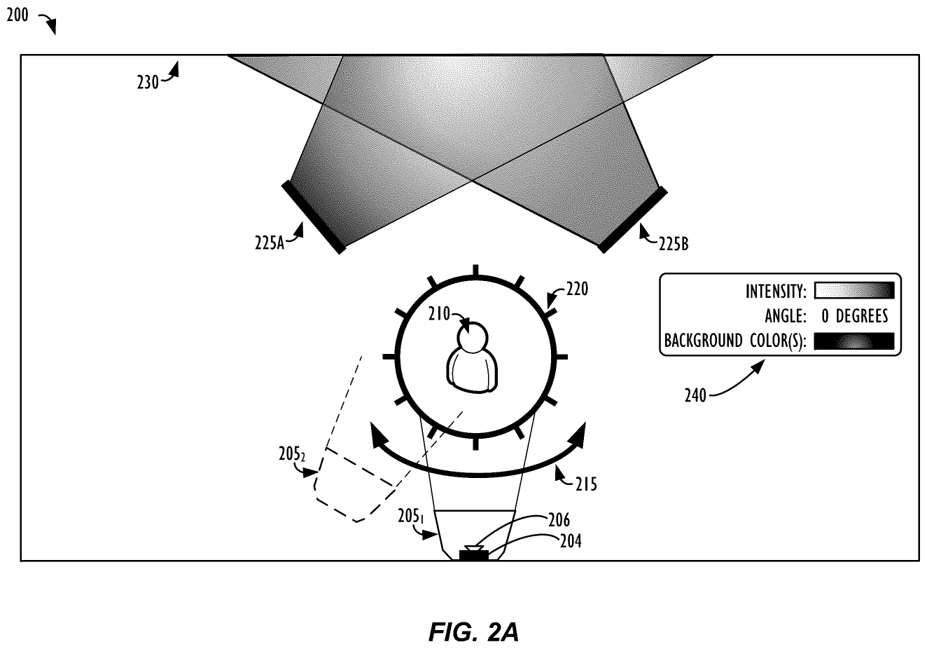

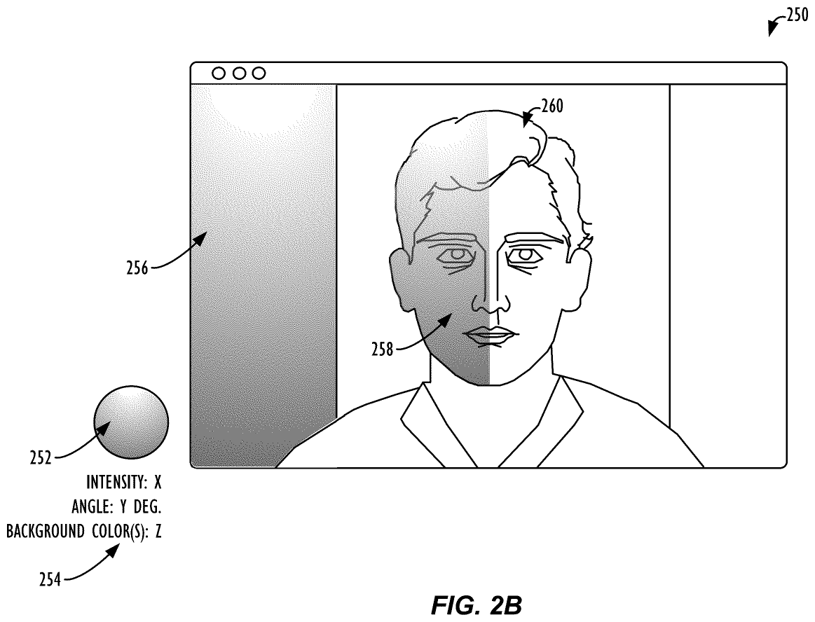

Turning now to FIG. 2A, an example 200 of virtual lighting visual effects for augmenting video image streams is shown, according to one or more embodiments. As shown in example 200, the customizable aspects of the virtual lighting visual effects include a moveable virtual “softbox” lighting source 205, as well as multiple environmental light sources (e.g., 225A/225B). It is to be understood that these numbers and positions of customizable aspects of the virtual lighting visual effects is merely exemplary and intended to be illustrative of possible customizable aspects.

In example 200, a human subject 210 is positioned in front of an electronic device 204 that has an image capture device 206 oriented in the direction of human subject 210. In one embodiment, the virtual softbox lighting source may be positioned at location 205₁, i.e., pointed directly at human subject 210, that is, having an offset angle of 0 degrees. With this positioning, the virtual light emanating from softbox 205 may have the most direct impact on portions of human subject 210 with estimated surface normals facing directly towards electronic device 204 and image capture device 206.

In another embodiment, e.g., after a user has modified the values of one or more of the characteristics of the virtual light source (as shown in box 240), e.g., the offset angle of the softbox 205, the virtual softbox lighting source may be positioned at location 205₂, i.e., pointed approximately 30 degrees to the right-hand side of human subject 210. With the updated positioning, the virtual light emanating from softbox 205 may have the most direct impact on portions of human subject 210 with estimated surface normals facing directly towards the updated virtual softbox location 205₂, as shown in FIG. 2A.

As may now be understood, with respect to the images being captured by image capture device 206 of electronic device 204 and augmented with virtual lighting effects, the human subject 210 may appear to have more dramatic lighting on the right-hand side of their face when the virtual softbox is positioned at location 205₂. It is also to be understood that many other characteristics of a virtual light source may be modified before being rendered into a captured scene in a physically realistic manner, e.g., the intensity, color, height, etc. of the virtual light source(s). For example, arrow 215 represents potential directions of movement of virtual light source 205 around a virtual path 220 circumscribing human subject 210, allowing a wide variety of lighting angles to be rendered upon human subject 210 (ranging from front-lighting to side-lighting to back-lighting).

According to some embodiments, the application of the virtual lighting visual effect may comprise one or more processors automatically determining an angle of a virtual light source that is to be added to the scene (e.g., an angle with respect to the image capture device, as described above). For example, in some implementations, a lighting angle may be automatically determined to balance out existing/natural lighting from the scene that is being cast upon human subject 210 so that, after application of the visual effect, the subject is evenly-lit. In other implementations, a lighting angle may be automatically determined to simulate (or enhance) the effect that a virtual (or real) light source in the scene may be having on human subject 210, and so forth.

Also illustrated in FIG. 2A are a pair of exemplary environmental light sources 225A/225B. These light sources may comprise the same color or different color(s) as virtual light source 205, as is desired in a given implementation. For example, environmental light sources 225A and 225B may be specified to have complimentary colors to one another, e.g., with light source 225A being blue and light source 225B being yellow, and so forth. According to some embodiments, the background of the captured scene may be lit in a different way than the foreground elements of the scene. For example, a depth-based falloff function may be employed that causes foreground objects (e.g., human subject 210) to be lit mostly by foreground lights (e.g., 205) and background objects (e.g., back wall 230) to be lit mostly by background lights (e.g., 225A/225B), while applying a smooth transition between the light sources when moving from foreground to background. As may now be appreciated, allowing the light sources to impact both foreground and background objects—but intelligently controlling their respective impacts, e.g., with a falloff function—helps achieve more realistic scene integration. For example, color spilling over from the background lights onto the foreground ties the scene together and motivates that the subject is actually in a scene that has those particular lights in the background.

Other numbers, combinations, and default positioning of virtual light sources is also possible, based on the needs of a given implementation. Preferably, any virtual light source that is added in the foreground portion of the scene has at least some impact on the background portion of the scene (and vice versa), i.e., in order to generate a more aesthetically-pleasing augmented image and to motivate the presence of a particular light source in the foreground of the scene by having it appear (at least subtly) in the background of the scene (and vice versa), as well.

Turning next to FIG. 2B, another example 250 of virtual lighting visual effects for augmenting video image streams is shown, according to one or more embodiments. As introduced above, the use of effective and/or interesting lighting on a presenter or participant in a videoconferencing session may be an important feature to add quality and enhance the content-sharing experience for both sending and receiving parties. However, it is not always possible for videoconferencing participants to employ sophisticated studio lighting set-ups during content sharing sessions, e.g., due to a lack of space, lack of time, lack of equipment, and/or lack of the necessary training/knowledge to light themselves (or their environment) in an effective and/or interesting manner.

Thus, it would be desirable if lightweight and efficient techniques could be employed to add customizable and intelligent virtual lighting effects to live video image streams, in order to augment the video image streams and provide a higher-quality image to receiving parties. Ideally, such virtual lighting effects may be applied in a performant manner, leverage existing segmentation/person identification techniques, be informed by the latest in AI/ML-based models for scene depth and/or surface normals estimation, and ultimately be composited and rendered into the augmented video images that are transmitted to a receiving party, such that the receiving party does not need to have any specialized software, features, or applications, in order to experience the augmented live video image stream that has had enhanced virtual lighting effects applied to it.

According to some embodiments, the virtual lighting effects may be applied only to the head or face area of an identified human subject (260) and/or to certain background surfaces (e.g., wall 256) in a live video image stream. This intentional limitation in the regions of the captured scene where the virtual lighting effects are applied may help to make the application of the virtual lighting effects more performant and/or avoid the application of the virtual lighting effects to areas of the captured scene wherein there is less confidence or knowledge in the depth and/or geometric structure of the surfaces and objects in the scene (e.g., backgrounds, walls, flat surfaces, dimly-lit regions of the scene, inanimate objects, etc.). Of course, if there was sufficient time, surface geometry confidence, and/or processing/thermal resources available to a sending electronic device, the virtual lighting effects described herein could also be applied to an entire captured video image frame.

According to some embodiments, the virtual lighting effects may utilize high quality, real-time maps of surface normals (e.g., as provided by one or more AI/ML-based or other image processing algorithms). Using such surface normal maps, for each relevant pixel in the video image (e.g., any pixel related to the head of a human subject detected in the image) it is possible to compute and determine the relationship of the object's surface at that pixel location with the virtual light source(s) that a user is attempting to augment the captured video image with. This allows the virtual lighting effects to dynamically track the movement of a user and/or changes in the scene over time—and thus appear more physically realistic than if, say, a static brightness filter were applied to all of the pixels in a particular portion of the captured video image.

Returning now to FIG. 2B, an exemplary picker user interface (UI) tool 252 is illustrated, which may provide a user with an array (254) of customizable colors, intensities, angles, positions (e.g., specifying an x-, y- and/or z-position in the scene of the virtual lighting source), number of virtual lighting sources, etc., that they would like to use augment the lighting of the captured video images. For example, in FIG. 2B, a user has chosen to apply a gradient lighting effect that appears to be coming from the left side of the image frame. Thus, only the left side 258 of human subject 260's face and a wall 256 on the left side of the image frame are visually affected by the selected virtual lighting effect. As may be understood the number, position, color, intensity, and/or angle of the virtual lighting source(s) may be changed or panned using a UI tool, such as 252, with the resulting effects being applied to the augmented live video image stream in real-time and then transmitted to the receiving party. It is also to be understood that any suitable picker UI tool may be used, depending on how much customizability or freedom that it is desired to give to a user, e.g., in terms of the choice or number of virtual lighting effects to be applied, and picker UI tool 252 is merely one possible example.

### Exemplary Methods of Augmenting Live Video Image Streams with Virtual Lighting Visual Effects

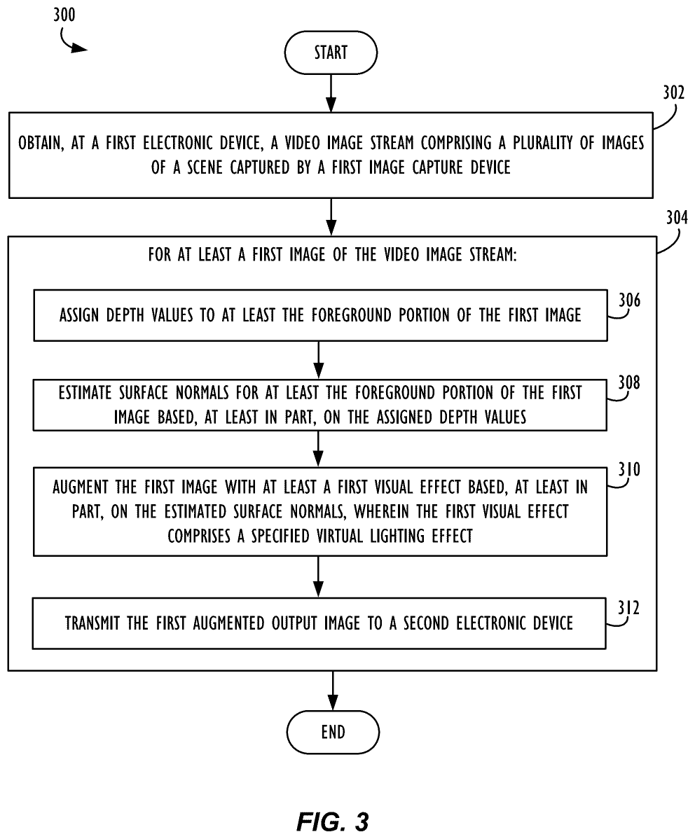

FIG. 3 is a flow chart, illustrating a method 300 of augmenting a live video image stream with virtual lighting visual effects, according to various embodiments. First, at Step 302, the method 300 may obtain, at a first electronic device, a video image stream comprising a plurality of images of a scene captured by a first image capture device. Next, the method 300 may initiate a for-loop 304, via which Steps 306-312 may be iteratively performed for each of one or more images of the video image stream. Steps 306-312 will be described herein in the context of being performed on a “first image” of the video image stream, although it is to be understood that one or more of Steps 306-312 may be similarly performed for any number of the images in the video image stream to which it is desired to apply depth-aware visual effects.

Turning now to Step 306, for at least a first image of the video image stream, the method 300 may assign depth values to at least the foreground portion of the first image. In some embodiments, the depth values may be estimated via stereo imagery, disparity calculations, Time of Flight (ToF) cameras, phase detection pixels, AI/ML-based monocular depth estimation frameworks, or whatever other depth estimation modality may be preferred or available in a given implementation.

Next, at Step 308, the method 300 may estimate surface normals for at least the foreground portion of the first image based, at least in part, on the assigned depth values. As described above, in some embodiments, the surface normal estimation operation may be enabled by one or more AI or ML-based algorithms, e.g., AI/ML-based algorithms trained to estimate normals directly from captured image data and/or scene depth estimates. Preferably, such surface normal estimation operations are performant (e.g., from both processing and thermal standpoints) and are able to deliver accurate (and sufficiently temporally-stable) surface normal maps for captured images in real-time, i.e., as captured video images are being streamed from an image capture device.

Next, at Step 310, the method 300 may augment the first image with at least a first visual effect based, at least in part, on the estimated surface normals, wherein the first visual effect comprises a specified virtual lighting effect. As described above, e.g., with reference to FIGS. 2A and 2B, many different types of depth-aware visual effects are possible to augment live video image streams, and those virtual relighting methods described herein are but several examples. As described above, by performing a physically-based rendering of the visual effects using the estimated surface normals, more realistic composited renderings may be made, e.g., involving lighting interactions and/or contextual-awareness between the visual effects and real objects (e.g., human subjects) and/or virtual objects in the captured images.

In some embodiments, in addition to applying the specified virtual lighting effect to the foreground at an infinity distance to the human subject, the foreground portion of the scene, and the background portion of the scene may simplify the process of rendering physically-realistic rendering results.

Finally, at Step 312, the method 300 may transmit the first augmented output image to a second electronic device. As described above, this transmission may be performed as part of a video image stream that is being transmitted to the second electronic device, according to any standardized or desired video transmission protocol, e.g., as part of a videoconferencing application, screen sharing application, or the like.

As may be appreciated, the various methods described herein, e.g., with reference to FIG. 3, may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s).

### Exemplary Electronic Computing Devices

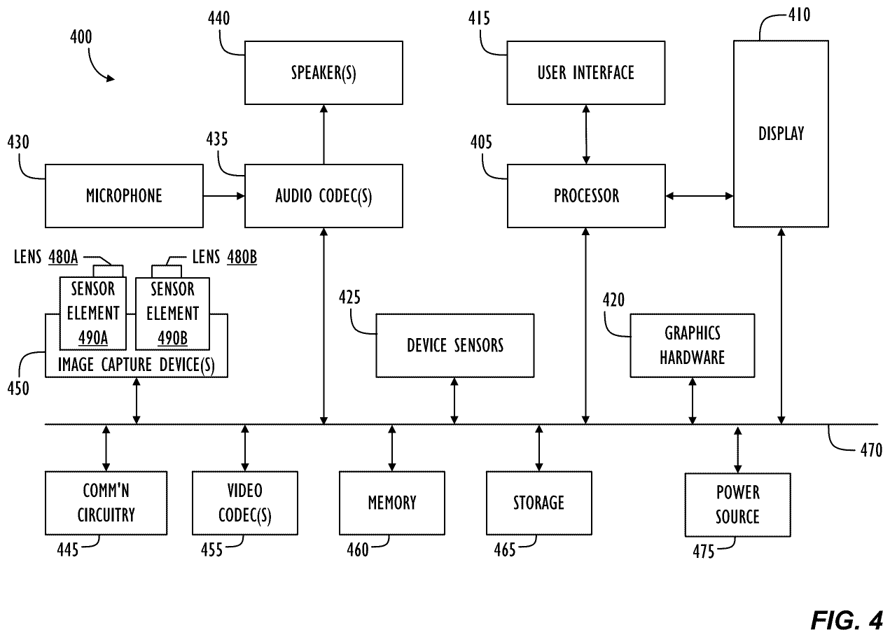

Referring now to FIG. 4, a simplified functional block diagram of illustrative programmable electronic computing device 400 is shown according to one embodiment. Electronic device 400 could be, for example, a mobile telephone, personal media device, portable camera, or a tablet, notebook or desktop computer system. As shown, electronic device 400 may include processor 405, display 410, user interface 415, graphics hardware 420, device sensors 425 (e.g., proximity sensor/ambient light sensor, accelerometer, inertial measurement unit, and/or gyroscope), microphone 430, audio codec(s) 435, speaker(s) 440, communications circuitry 445, image capture device 450, which may, e.g., comprise multiple camera units/optical image sensors having different characteristics or abilities (e.g., Still Image Stabilization (SIS), HDR, OIS systems, optical zoom, digital zoom, etc.), video codec(s) 455, memory 460, storage 465, and communications bus 470.

Processor 405 may execute instructions necessary to carry out or control the operation of many functions performed by electronic device 400 (e.g., such as the generation, processing, and/or streaming of images and video data in accordance with the various embodiments described herein). Processor 405 may, for instance, drive display 410 and receive user input from user interface 415. User interface 415 can take a variety of forms, such as a button, keypad, dial, a click wheel, keyboard, display screen and/or a touch screen. User interface 415 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 410 may display a video stream as it is captured while processor 405 and/or graphics hardware 420 and/or image capture circuitry contemporaneously generate and store the video stream in memory 460 and/or storage 465. Processor 405 may be a system-on-chip (SOC) such as those found in mobile devices and include one or more dedicated graphics processing units (GPUs). Processor 405 may be based on reduced instruction-set computer (RISC) or complex instruction-set computer (CISC) architectures or any other suitable architecture and may include one or more processing cores. Graphics hardware 420 may be special purpose computational hardware for processing graphics and/or assisting processor 405 perform computational tasks. In one embodiment, graphics hardware 420 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 450 may comprise one or more camera units configured to capture images, e.g., images which may be processed to generate cropped, augmented, and/or distortion-corrected versions of said captured images, e.g., in accordance with this disclosure. Image capture device(s) 450 may include two (or more) lens assemblies 480A and 480B, where each lens assembly may have a separate focal length. For example, lens assembly 480A may have a shorter focal length relative to the focal length of lens assembly 480B. Each lens assembly may have a separate associated sensor element, e.g., sensor elements 490A/490B. Alternatively, two or more lens assemblies may share a common sensor element. Image capture device(s) 450 may capture still and/or video images. Output from image capture device 450 may be processed, at least in part, by video codec(s) 455 and/or processor 405 and/or graphics hardware 420, and/or a dedicated image processing unit or image signal processor incorporated within image capture device 450. Images so captured may be stored in memory 460 and/or storage 465.

Memory 460 may include one or more different types of media used by processor 405, graphics hardware 420, and image capture device 450 to perform device functions. For example, memory 460 may include memory cache, read-only memory (ROM), and/or random access memory (RAM). Storage 465 may store media (e.g., audio, image and video files), computer program instructions or software, preference information, device profile information, and any other suitable data. Storage 465 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 460 and storage 465 may be used to retain computer program instructions or code organized into one or more modules and written in any desired computer programming language. When executed by, for example, processor 405, such computer program code may implement one or more of the methods or processes described herein. Power source 475 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 400.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method, comprising:
obtaining, at a first electronic device, a video image stream comprising a plurality of images of a scene captured by a first image capture device; and
for at least a first image of the video image stream:
assigning depth values to at least a foreground portion of the first image;
estimating surface normals for at least the foreground portion of the first image based, at least in part, on the assigned depth values;
augmenting the first image with at least a first visual effect based, at least in part, on the estimated surface normals, wherein the first visual effect comprises a specified virtual lighting effect; and
transmitting the first augmented output image to a second electronic device.

2. The method of claim 1, wherein estimating the surface normals comprises using a machine learning (ML) or artificial intelligence (AI)-based model.

3. The method of claim 1, wherein the steps of: assigning, estimating, augmenting, and transmitting are further performed for each image of the video stream.

4. The method of claim 1, wherein the first augmented output image is transmitted to a second electronic device as part of a videoconferencing application.

5. The method of claim 1, wherein the foreground portion of the first image comprises at least one human subject.

6. The method of claim 1, wherein the specified virtual lighting effect comprises a specification of at least one of:
(a) a color of a virtual light source being added to the scene;
(b) an intensity level of a virtual light source being added to the scene;
(c) an angle of a virtual light source being added to the scene with respect to the first image capture device;
(d) a number of virtual light sources being added to the scene; or (e) a position of one or more virtual light sources being added to the scene.

7. The method of claim 1, wherein the specified virtual lighting effect comprises a virtual light source that is modeled as being added to the scene at an infinity distance.

8. The method of claim 1, wherein the first visual effect comprises an application of one or more temporal stability constraints.

9. The method of claim 1, wherein the first visual effect comprises automatically determining an angle of a virtual light source being added to the scene with respect to the first image capture device.

10. The method of claim 1, wherein the specified virtual lighting effect comprises modeling an effect of a virtual light source being added to the scene on a virtual background for the scene.

11. An electronic device, comprising:
a first image capture device;
a memory; and
one or more processors operatively coupled to the memory, wherein the one or more processors are configured to execute instructions causing the one or more processors to:
obtain a video image stream comprising a plurality of images of a scene captured by the first image capture device; and
for at least a first image of the video image stream:
assign depth values to at least a foreground portion of the first image;
estimate surface normals for at least the foreground portion of the first image based, at least in part, on the assigned depth values;
augment the first image with at least a first visual effect based, at least in part, on the estimated surface normals, wherein the first visual effect comprises a specified virtual lighting effect; and
transmit the first augmented output image to another electronic device.

12. The electronic device of claim 11, wherein estimating the surface normals comprises using a machine learning (ML) or artificial intelligence (AI)-based model.

13. The electronic device of claim 11, wherein the steps of: assigning, estimating, augmenting, and transmitting are further performed for each image of the video stream.

14. The electronic device of claim 11, wherein the specified virtual lighting effect comprises a specification of at least one of:
(a) a color of a virtual light source being added to the scene;
(b) an intensity level of a virtual light source being added to the scene;
(c) an angle of a virtual light source being added to the scene with respect to the first image capture device;
(d) a number of virtual light sources being added to the scene; or
(e) a position of one or more virtual light sources being added to the scene.

15. The electronic device of claim 11, wherein the first visual effect comprises an application of one or more temporal stability constraints.

16. A non-transitory computer-readable medium (CRM) comprising computer readable instructions executable by one or more processors to:
obtain a video image stream comprising a plurality of images of a scene captured by a first image capture device of a first electronic device; and
for at least a first image of the video image stream:
assign depth values to at least a foreground portion of the first image;
estimate surface normals for at least the foreground portion of the first image based, at least in part, on the assigned depth values;
augment the first image with at least a first visual effect based, at least in part, on the estimated surface normals, wherein the first visual effect comprises a specified virtual lighting effect; and
transmit the first augmented output image to a second electronic device.

17. The non-transitory CRM of claim 16, wherein estimating the surface normals comprises using a machine learning (ML) or artificial intelligence (AI)-based model.

18. The non-transitory CRM of claim 16, wherein the steps of: assigning, estimating, augmenting, and transmitting are further performed for each image of the video stream.

19. The non-transitory CRM of claim 16, wherein the specified virtual lighting effect comprises a specification of at least one of:
(a) a color of a virtual light source being added to the scene;
(b) an intensity level of a virtual light source being added to the scene;
(c) an angle of a virtual light source being added to the scene with respect to the first image capture device;
(d) a number of virtual light sources being added to the scene; or
(e) a position of one or more virtual light sources being added to the scene.

20. The non-transitory CRM of claim 16, wherein the first visual effect comprises an application of one or more temporal stability constraints.
